(19) United States
(12) Patent Application Publication
(10) Pub. No.: US 2015/0175115 A1
(43) Pub. Date: Jun. 25, 2015

(54) COVER FOR INFLATABLE OBJECT

(71) Applicant: CCL LABEL, INC., Farmingham, MA (US)

(72) Inventor: Richard L. Sandt, Brunswick, OH (US)

(21) Appl. No.: 14/415,615

(22) PCT Filed: Jul. 19, 2013
(86) PCT No.: PCT/US2013/051284

§ 371 Date: Jan. 19, 2015

Related U.S. Application Data
(60) Provisional application No. 61/673,789, filed on Jul. 20, 2012.

(51) Int. Cl. B60R 21/201; B65B 5/04

(52) U.S. Cl. CPC B60R 21/201; B65B 5/04

(57) ABSTRACT

The present invention discloses a cover material for an inflatable object such as an air bag. Generally, the cover surrounds the entire inflatable object. The cover has a valve to allow for vacuum compression of the inflatable object. In one embodiment the cover material is constructed out of heat shrinkable material so that the construction may be both compressed and shrunk to allow for the inflatable object to occupy less area. The present invention also discloses a method of constructing an encapsulated inflatable object utilizing the cover presently disclosed.

### CROSS-REFERENCE TO RELATED APPLICATION

This application claims the benefit of U.S. Provisional Application No. 61/673,789 filed on Jul. 20, 2013 and entitled “Cover for Inflatable Object,” which is hereby incorporated in its entirety by reference.

### FIELD

The invention generally relates to covers used with inflatable objects particularly airbags that aid in the reduction of the object's volume.

### BACKGROUND

Airbags are common and often legally required safety equipment when provided in motor vehicles and are designed to offer added protection to occupants in the event of an accident. A conventional vehicular airbag assembly typically includes a gas-inflatable bag which is retained in its collapsed stowed state within a housing and inflates (rapidly) in response to a certain level of impact from a vehicle striking or being struck in one or more directions.

Large manufacturers of automobiles initially provided airbags in the steering wheels of automobiles (driver air bag). Later, passenger, knee, and side impact air bags became increasingly common. There are approximately 140-160 million “frontal” air bags sold each year which includes driver air bags, passenger and knee are bags.

Airbag covers often function to keep the stowed airbag in its folded state and to generally protect the airbag. Airbag covers (wraps) that are made from fabric or thin pliable plastics are particularly useful in mounting side curtain airbags where more rigid housings can be difficult to effectively use due to the limited spaced offered by recesses often used for mounting the airbags around the openings defining passenger doors and windows.

Important properties of any housing or cover for a vehicular airbag includes that the housings or covers should be forced open reliably and nearly instantaneously upon deployment of the airbag, which, for example can happen within a fraction of a second (e.g., within milliseconds for some airbag assemblies) after some predetermined level of impact. It is also usually desirable that the airbag housing opens at a predetermined level of impact. It is also usually desirable that the airbag housing opens at a predetermined portion (s) in order to assist in properly deploying the airbag in a desired orientation. Known airbag housings often have a frangible feature such as a line/region of mechanical weakness (e.g., a perforation) that fails when a certain amount of force is applied.

Automotive companies are demanding larger bags while leaving less room for the air bag module throughout the automobile. Therefore, there is a need in the market place for a cover for an airbag module that reduces the volume of the airbag so that it takes up less space in the automobile when in the stowed position. The present invention proposes using a valve such as the valve as set forth in U.S. Pat. No. 7,685,795, which is incorporated herein by reference, in cooperation with heat shrinkable material to achieve an airbag module that has a minimal total volume and which is capable of occupying a small space when stowed but also which releases effectively upon impact.

### BRIEF SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

According to one embodiment of the present invention, a cover for an inflatable object is provided. The cover, in one embodiment, is constructed out of heat shrinkable material and surrounds the entirety of the inflatable object. The cover optionally has at least one opening to allow for placement of a valve for air removal and compression purposes.

According to another embodiment of the present invention, a method of making a package-like construction using the cover of the present invention for an inflatable object, such as an air bag, is provided. This method includes placing an inflatable object in between a top and bottom section of cover material, aligning the perimeters of the top and bottom section of the cover and sealing the perimeters of the top and bottom section to form a package for the inflatable object.

According to another embodiment of the present invention, an additional method for constructing a package for an inflatable object using the cover presently described is provided in which the cover material is not separated into a top and bottom section and in which the perimeter of the first section is aligned with the perimeter of the second section and a majority of the perimeter of the first and second section are sealed together leaving an unsealed portion which forms an opening for the inflatable object. The inflatable object is inserted into this opening and the unsealed portion is then sealed to form an encased inflatable object. The material used to encase the inflatable object may be a heat shrinkable material and may optionally consist of an opening for removal of air. The opening may be covered with an adhesive coated tape to prevent the entry of air removal or the opening may include a valve which can be removed but which creates a seal preventing entry of air.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 illustrates an airbag encased with a cover having the valve depicted in FIG. 1.

FIG. 2 illustrates one embodiment of the cover of the present invention prior to encapsulating an inflatable object.

FIG. 3 illustrates an alternative embodiment of the cover of the present invention in which the cover consists of first and second sections which are sealed to one another to create a package for an air bag module.

### DETAILED DESCRIPTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

Embodiments of the present invention may be suitable for retaining/and or enclosing an inflatable, expandable object such as an air bag. More specifically, the present invention provides for a cover for an inflatable object such in which the cover has an opening in the cover to allow for vacuum compression of the inflatable object. The vacuum compression may be accomplished using various means known in the art. The opening may optionally contain a valve through which a vacuum can be pulled. In another embodiment, upon pulling of the vacuum, the at least one opening can be covered with an adhesive backed tape, a liquid sealant, heat may be applied to thermally bond the film closing the opening, or a heat activated tape or path may be applied to the at least one opening in order to prevent the re-entry of air. One embodiment fully described in U.S. Pat. No. 7,685,793 which is incorporated herein by reference, may be adhered to the cover for the inflatable object as presently described. While this construction illustrates a preferred valve construction of the present invention, it is contemplated that many different types of constructions of valves may be utilized with the cover described herein. The cover material may be heat shrinkable or not when used in conjunction with vacuum assisted compression.

As previously described, the cover itself may be constructed out of heat shrinkable material allowing for the construction to be heat shrunk. Thus, the cover of the present invention when wrapped around an inflatable object to completely encase the object, allows for compression via the utilization of a valve or alternatively the heat shrinkable material may be compressed in a mold and simultaneously shrunk. In an alternate embodiment, the opening may be used in conjunction with the compression wherein a vacuum or partial vacuum may be pulled on the cover prior to compression molding and shrinking. The utilization of both compression via vacuum or compression mold and shrinkage allows for the air bag to occupy a significantly smaller volume than other air bag constructions currently in the market place.

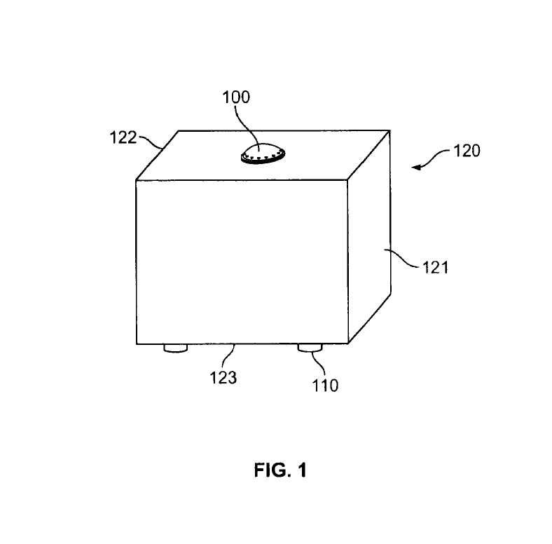

The following description illustrates one example of a construction of the invention and is for illustration purposes and does not illustrate the scope of the entire invention. Referring to FIG. 1, an inflatable object, such as an airbag, is fully encased with a cover 121 having a valve 100 such as described in U.S. Pat. No. 7,685,795. Generally the airbag has a particular volume and a top face 122 and a bottom face 123. The cover 121 completely encases the entire volume of the airbag. In one embodiment, the airbag may be coated with a low surface energy coating such as silicone, carbamate or rhodium prior to being encased with the cover 121. It is generally known in the art, that an airbag typically has fixtures such as bolts 110 for attachment purposes. For instance, with a driver's air bag, the air bag will have a number of bolts, approximately four, in order to attach and secure the air bag to the steering wheel. Generally an air bag can be any shape when collapsed. In the present application, the airbag, in its compressed state is shown in a cube-line configuration and sits on a support. The support may be a metal or plastic but is not limited to such. It is well known in the art that generally air bags resemble a cement brick and this is referred to as “brick style.” Driver side air bags as well as side impact seat cushion bags have a tendency to be constructed in this “brick style,” rectangular design. Space is becoming an issue for “brick style” air bags. While “brick style”, square airbags are prevalent in today's marketplace, an air bag may be formed in other geometric shapes, as well.

The cover 121 may be made of heat shrinkable material. Suitable heat shrinkable material may that may be used in the present invention include but is not limited to the following: polyolefins including LLDPE, LLDPE/EVA blends, polypropylene and polystyrene, (PS or OPS), PETG, PVX, PLA, PS/PE blends, nylon, other polyamides, polyimides or blends thereof, and various blends or multilayer combinations of these polymers, thermo plastic polyurethane, various polyethylene and propylene blends, PVC, and polyester. The present invention also contemplates that the heat shrinkable material is a heat shrink fluoropolymer film such as PTFE. The present invention also contemplates that the cover 121 may be constructed out of non-heat shrinkable material such as non-heat shrink films of the polymers previously listed. In a preferred embodiment, the thickness of the heat shrinkable material is between 4 and 7 mils. In another embodiment, the thickness of the heat shrinkable material is within the range of 0.5 mil-20 mil.

The present invention contemplates that in one embodiment the cover comprises a heat shrinkable material and a fire retardant additive. Suitable fire retardant additives include but are not limited to zinc borate, metal hydroxides such as alumina trihydrate and magnesium hydroxide, halogenated materials such as chloro or brominated oils and waxes, antimony oxide, phosphorous compounds such as phosphate esters, phosphonates, halogenated esters of phosphates, nitrogen compounds such as ammonium polyphosphates, melamine phosphates, borate cyanurate, metallic borates, stannates and molybdates. Additionally, although brominates compounds, specifically PBDE's are being regulated out of use due to health and environmental concerns, polybrominated diphenyl ethers (PBDEs) including the commercial versions of pentabromodiphenyl ether (c-pentaBDE), octabromidphenl ether (C-octaBDE), and decabromodiphenyl ether (C-decaBDE) may be used as flame retardants in a number of applications, including textiles, plastics, wire insulation, and automobiles.

The cover 121 presently disclosed entirely wraps the air bag in order to form a seal around the air bag. The airbag may be vacuum compressed via pulling a vacuum through the valve 100. Alternatively, the airbag may be compressed by a compression mold or other type of compression device. The utilization of a heat shrinkable material in the cover would significantly reduce any leakage from being an issue. Once the sealed cover is evacuated and shrunk, if heat shrinkable material is utilized for the cover, if a hole develops in the cover of the airbag, an air bag encased with the heat-shrinkable cover presently disclosed will resist expansion because it is shrunk after pulling a vacuum and it is able to hold most of its vacuum compressed size and shape due to the shrinkage of the heat shrinking material. In one embodiment, the present invention contemplates that the cover may be shrunk in other conventional shrink methods. For instance thermal energy may be used for shrink the cover. The thermal energy may be generated by steam, UV, IR, or electron beam technology.

In another embodiment of present invention, the cover is not constructed of heat shrinkable material. However, the non-shrinking cover material should be conformable in order to tightly compress the air bag under a vacuum. In one embodiment of the present invention the cover material has a tensile strength of 2800 PSI per ASTM method D-882 in both directions and a tear strength of 570-1050 grams per ASTM method D-1922. In another embodiment, the cover material of the present invention has a tensile strength of 1500-1800 PSI. It is also important that the cover material is able to maintain its integrity when subjected to different environmental factors. For instance, it is required that the material does not rip, fracture, or tear when subjected to freezing temperatures or when subjected to extreme heat.

In one embodiment, the cover material of the present invention preferably has no more than 20% loss of tensile strength and maintains its integrity during air bag deployment testing at 95° C., at −30° C. and at 85° C., 95% RH. Cover material of the present invention, when subjected to several environmental tests, did not lose more than 20% of its original tensile strength. The tests include subjecting the cover material to the following conditions: 107° C. for 408 hr and 70° C. at 95% RH for 408 hr. The temperature cycles for the testing was as follows: 70° C. at 95% RH for 19 hr, 107° C. for 29 hr and 70° c. at 95% RH for 19 hr. During the testing, the cover material of the present invention met FMVSS302 Flame Retardance requirements.

The cover 121 of the present invention should also be flame retardant and meet the automotive flame retardant standard FMVSS302.

In one embodiment, the cover 121 has at least one opening, preferably but not limited to the portion of the cover 121 that overlies the top face 122 of the airbag or other type of inflatable object. The at least one opening or portal may be made in the cover 121 by means known in the art which includes but is not limited to punching an opening, die cutting, laser scoring, or blade scoring. An air control device 100 such as the valve illustrated in U.S. Pat. No. 7,685,793, can be placed over the at least one opening in the cover 121. The air control device 100 may be adhered to the cover 121 with an adhesive that is part of the air control device's construction. In another embodiment, the air control device 100 may be adhered to the cover using a separate adhesive backed laminate such as a tape that comprises an adhesive such as for example a pressure sensitive adhesive, a liquid adhesive, or a heat activated adhesive. In another embodiment, the air control device 100 may be molded into the cover material 121 or the air control may be a molded plastic construction that is heat sealed into the cover material 121. The cover 121 may also have one or more openings in the portion of the cover that covers the bottom face 123 of the airbag. The opening(s) in the portion of the cover 121 that covers the bottom face 123 of the airbag may be used for the security of the airbag to a support frame or other mechanism for attachment to another object, such as a car. Therefore in one exemplary embodiment of the invention, there will be four openings in the portion of the cover 121 that covers the bottom face 123 of the airbag where bolts will be used to attach the air bag encompassed in the cover to a support frame. However, as stated previously, the present invention contemplates that the portion of the cover 121 that covers the bottom face 123 of the airbag may have more or less than four openings.

In one embodiment, a second material covers each of the openings in the portion of the cover 121 that covers the bottom face 123 of the airbag. This second material may be a type of gasket material which may be utilized to effect or improve the sealing of the cover in order to prevent air leaks specifically around the bolts or other type of attachment mechanism on the bottom of the air bag module. Suitable gasket materials include but are not limited to films, closed cell foams such as poron, other polyolefin foams, closed cell foams such as neoprene and other synthetic rubbers, polyolefin blends including those made of PE, PP, EVA, LLDPE thermoplastic urethane, and other types of flexible material not listed. The gasket material has at least one opening to accommodate the openings in the portion of the cover 121 that overlies the bottom face 123 of the airbag. The gasket material may be provided as a single piece of material that covers the entire portion of cover that overlies the bottom face 123 of the airbag. In an exemplary embodiment, the gasket material can be die cut so that the one piece of material contains holes for each of the bolts of the air bag and which may have a large center hole that may house an air bag inflator. In another embodiment, the gasket may be divided into a plurality of different pieces of material so that each opening in the cover that overlies the bottom face 123 of the airbag is covered with a single piece of gasket material. In this embodiment, the gasket material may take the form of individual pieces of gasket material that are place over each opening through which a security mechanism, such as a bolt, is placed. Thus, the gasket material would surround the openings in the cover and not completely cover the remainder of the cover that overlies the bottom face 123 of the airbag. The present invention contemplates that the gasket material may be placed over the backside of the airbag prior to encapsulating the air bag with the cover material or the gasket material may be placed over and/or on top of the cover material.

The holes in the gasket material may be die or punch cut and in one embodiment the openings in the gasket material have a diameter smaller than that of the bolts of the air bag to assure a tighter fit in an exemplary embodiment. The bolts 110 on the bottom face of the airbag are inserted through the at least one opening in the portion of the cover 121 that overlies the bottom face 123 of the airbag as well as the at least one opening of the gasket material that overlies the at least one opening in the portion of the cover 121 that overlies the bottom face 123 of the airbag. This material is adhered to the cover with a type of adhesive such as a high tack pressure sensitive adhesive, a permanent adhesive, removable adhesive, and/or pressure sensitive adhesive. The gasket may also be applied as a separate material that is applied around the bolts of an airbag. In this embodiment, the gasket material is not adhered to the cover material. The gasket material is utilized to achieve a more effect seal around the bolts 110 of the airbag, but is not required.

In another embodiment a washer may be added around the base of each bolt of the air bag or a significant portion of the bolts may be smooth and not threaded in order to achieve a more robust seal.

In one embodiment, the gasket material may consist of an adhesive layer such as a layer of pressure sensitive adhesive to assist in the anchorage of the gasket material to the back of the air bag assembly. In another embodiment, the gasket material does not utilize an adhesive layer.

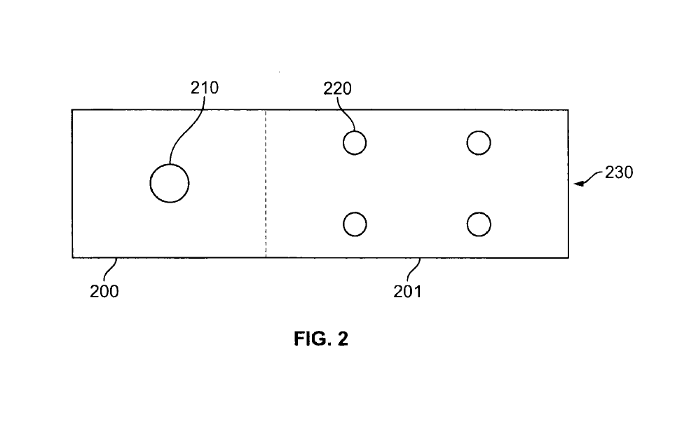

The present invention contemplates that the cover material may be provided from the manufacturer of the cover material to the customer in a plurality of different designs to as to make it easy for customers to fully surround the air bag or other inflatable object with the cover material. This will aid in reduced costs for the customer and a more efficient workflow. In one embodiment of the present invention as illustrated in FIG. 2 of the present invention, the cover material 230 for an inflatable object may be provided as a continuous sheet of material having a first 200 and second section 201. The first section 200 has an opening 201 over which a valve or other type of multi layer control device will be placed. The second section 201 has a plurality of openings 220 through which the bolts of an air bag will fit. In this embodiment, the cover material may be provided to the customer in roll form or individual sheet form. While the embodiment set forth only utilizes a first and second section, the present invention contemplates that the continuous sheet of cover material may be divided into more than two sections.

In one embodiment, a package for which an air bag or other inflatable object may be inserted is constructed utilizing the continuous sheet of cover material illustrated in FIG. 2. First an air bag and having a top and bottom face is provided and having a perimeter is provided. The air bag contemplated by the present invention has a wide range of possible perimeters and is not limited to any one perimeter. In one embodiment, a folded air bag having a base has a perimeter in the ranges of 12-15 cm×10-15 cm×4-5 cm. In another embodiment, the air bag may have a perimeter in the ranges of 10-12 cm×9-11 cm×5-5.5 cm. In another embodiment the perimeter measures 12 cm×31 cm×1 cm, and in another embodiment the perimeter may measure 21 cm×10 cm×4 cm. Second, a cover material having a first 200 and second section 201 are provided. The first section having a top and bottom face and a perimeter larger than the air bag. In another embodiment, the first and second section has a perimeter that is the same as the air bag. The second section of the cover material also has a top and bottom face and a perimeter larger than the air bag. The first section has at least one opening and the second section of the cover material has a plurality of openings. A sealing mechanism such as a valve set forth in U.S. Pat. No. 7,685,795 or a sealing tape or other sealing mechanism is placed over the top face of the first section of the opening. In one embodiment, a valve is adhered to the cover material by a pressure sensitive adhesive. Third, the perimeter of the first section is aligned with the perimeter of the second section in order to form a seal as needed on one or more sides of the cover material. A majority of the perimeter of the perimeter of the first is sealed to the perimeter of the second section forming a package-like construction for an airbag or other inflatable object. The sealing may be accomplished using heat, sonic energy, UV adhesive or with a mechanical fastener, but is not limited to these methods and other conventional sealing techniques can be employed. A portion of the perimeter of the first section and a portion of the perimeter of the second section are left unsealed forming an opening. Generally, the opening is large enough so that the air bag or other type of inflatable object may be inserted in between the first and second section. Next, the air bag is inserted in-between the opening formed by the unsealed portions of the first and second sections so that the top face of the air bag is in contact with the bottom face of the first section of material and the bottom face of the air bag module is in contact with the top face of the second section of material. When present, the bolts on the bottom face of the air bag are aligned with the plurality of opening in the second section and the bolts are inserted through the second section. Lastly, the package is compressed via the opening and optionally shrunk.

The present cover configuration and methods for encasing an object with such covers allows for covers to be provided that comprise openings, e.g., openings for the bolts, small perforations, or other openings that exist in the cover during heat shrinkage and after. That is, an object can be encased within the cover even if the cover does not have an air tight seal.

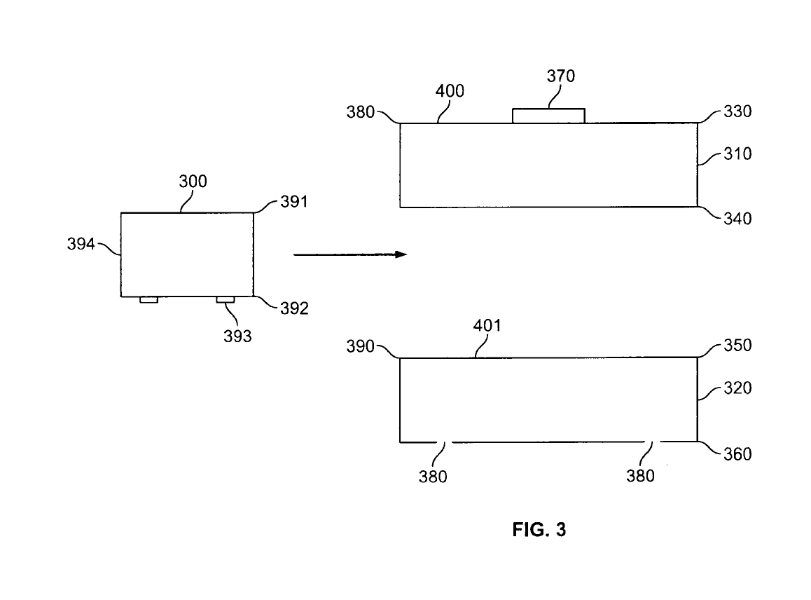

In another embodiment as illustrated in FIG. 3 of the present invention, the first 310 and second sections 320 of cover material in FIG. 2 are separated from one another which is distinguishable from the method previously set forth in which the first and second section remain connected to one another when encompassing the air bag. The present invention contemplates that the cover material may be divided into a plurality of sections and is not limited to two individual sections. The first and second sections may be separated by die cutting or any other means known means in the art such as rotary, flat die, clamshell, laser cutting, thermal cutting, plotter cutting or other mechanized forms of blade, die tool cutting, or the sections could be manually cut. First, an inflatable object 300 such as an air bag having a perimeter 394 and a top 391 and bottom 392 is provided wherein the bottom face 392 has a plurality of bolts 393 if the inflatable object 300 is in fact an air bag cushion assembly or module 300. A sheet of material having a first 310 and second 320 section is also provided. The first section 310 of material has a perimeter 394 larger than the inflatable object 300 and having a top 330 and bottom 340 faces. The second section 320 of material also has a perimeter 390 larger than the inflatable object 300 and a top 350 and bottom 360 faces. The first section has an opening and the second section of material has a plurality of openings. In an exemplary embodiment, a valve 370 is placed over the opening on the top face over the opening. However, the opening may be left open, and after removal of air, may be sealed with a tape or other sealing mechanism. The first 310 and second 320 section materials are separated from one another to form independent pieces of cover material. The first section forms a top 380 section and the second section forms the bottom 390 section. An inflatable object 300 is placed in between the top 380 and bottom 390 section of cover material so that the top face 391 of inflatable object 300 is in contact with the bottom face 340 of the first section of the cover material and the bottom face 392 of the inflatable object 300 is in contact with the top face 391 of the second section 392 of the cover material. The perimeter 380 of the first section 310 of the cover material and the perimeter 390 of the second section 320 of cover material are aligned and the perimeters are sealed to one another forming a package. The sealing may be accomplished using heat, sonic energy, UV, adhesive or with a mechanical fastener but is not limited to these methods. If the inflatable object is an air bag, bolts 393 on the bottom face of the air bag are aligned with the plurality of openings in the second section of the cover material prior to the sealing step.

In order to ensure that the air bag module deploys when subjected to a certain amount of force, the valve may act as an area weakness that when impacted releases the air bag. An opening through which air is removed may act as an area of weakness in the cover material. In another embodiment, a line of weakness may be cut into the cover material. For instance, in one embodiment, a line of partial perforations may be cut into the cover material across a portion of the cover material's diameter to allow for activation of the air bag. The area of weakness may be a “score line” in which a cut is partially cut into the cover material by a rotary die or other means known in the art. In another embodiment, an area of weakness may be constructed by chemically etching a line, creasing a fold, or using down gauging in the cover material.

In one embodiment, the present invention contemplates a method for sealing the at least one opening in the cover material presently. First at least opening is created in the cover material. The opening by means known in the art such as, but not limited to, punching die cutting, laser scoring, or blade scoring. A vacuum is applied through the at least one opening via various methods known in the art. Lastly, the at least one opening is sealed by methods including, but not limited to, applying a pressure sensitive tape, applying a liquid sealant, applying heat to thermally bond the film, or applying a heat activated tape or patch.

It will thus be seen according to the present invention a highly advantageous cover for an inflatable object, particularly an air bag has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

What is claimed is:

1. A cover for an inflatable object having a volume and a top and bottom face, comprising
a cover made of heat shrinkable material wherein the cover encapsulates the volume of the object.

2. The cover of claim 1, wherein there is at least one opening in a first portion the cover that overlies the top face of the object.

3. The cover of claim 2, wherein there are a plurality of openings in a second portion of the cover that overlies the bottom face of the object.

4. The cover of claim 3, wherein a sealing mechanism for sealing the at least one opening in the cover overlies the top face of the object.

5. The cover of claim 4, wherein the sealing mechanism is a valve.

6. The cover of claim 5, wherein the valve is a one way valve.

7. The cover of claim 5, wherein the valve is backed with pressure sensitive adhesive.

8. The cover of claim 4, wherein the sealing mechanism is a tape.

9. The cover of claim 8, wherein the tape is a pressure sensitive tape.

10. The cover of claim 1, wherein the inflatable object is an air bag.

11. The cover of claim 3, wherein the cover further comprises a second material covering each of the one or more openings in the second portion of the cover that overlies the bottom face of the air bag module wherein the second material has a plurality of openings that align with the openings in the cover of the material that overlies the bottom face of the air bag module.

12. The cover of claim 11, wherein the air bag has a top and bottom face and further has a plurality of fixtures on its bottom face.

13. The cover of claim 12, wherein the fixtures insert through the one or more opening in the second material and the plurality of openings that overlies the bottom face of the air bag module.

14. The cover of claim 11, wherein the second material comprises a film, foam or other flexible material.

15. The cover of claim 11, wherein the second material is applied to the cover of the material that overlies the bottom face of the air bag module with a pressure sensitive adhesive.

16. The cover of claim 10, wherein the air bag has a top and bottom face and has a plurality of fixtures on its bottom face and a second material is applied around the plurality of fixtures wherein the second material is not adhered to the cover.

17. A cover for an inflatable object, comprising:
a cover made of a heat shrinkable material having a first and second section;
the first section having an opening;
the second section having a plurality of openings; and
a valve that overlies the opening in the first section of the cover.

18. The cover of claim 17, wherein the cover is made to encapsulate an air bag.

19. The cover of claim 17, wherein the material meets the automotive flame retardant standard FMVSS302.

20. The cover of claim 17, wherein the cover is provided as a roll of material.

21. A method of making a package for an inflatable object comprising the steps of:
providing an inflatable object with a perimeter and having a top and bottom face;
providing a sheet of material having a first and second section, the first section with a perimeter larger than the perimeter of the inflatable object and a top and bottom face and the second section with a perimeter larger than the perimeter of the inflatable object and a top and bottom face wherein the first section has an opening, and a valve placed on the top face of the first section over the opening;
separating the first and second section of material to form a top and bottom section;
placing the inflatable object in between the top and bottom section of the cover material so that the top face of the inflatable object is in contact with the bottom face of the first section of the cover and the bottom face of the inflatable object is in contact with the top face of the second section of the material;
aligning the perimeter of the first section of the cover and the second section of the cover; and
sealing the perimeters of the first section of the cover to the second section of the material.

22. The method of claim 21, wherein first and second section of material are heat shrinkable material.

23. The method of claim 21, wherein the first and second section of material lose a maximum of 20% of original tensile strength.

24. The method of claim 21, the inflatable object is an airbag.

25. The method of claim 21, wherein the second section of material has a plurality of openings.

26. The method of claim 21, wherein the valve comprises a casing having a shell portion which is deformable from an open condition, whereat the shell portion forms a chamber over the port area, and a closed position condition, whereat the shell portion contacts the port area; gas-releasing openings in the casing, through which gas exits from the chamber when the shell portion is in the opened condition; and
a port-sealing adhesive adhering the shell portion to the port area when it is in the closed condition.

27. A method of making a package for an air bag comprising the steps of:
providing an air bag with a perimeter and having a top and bottom face wherein the bottom face has a plurality of bolts;
providing a first and second section of material, the first section with a perimeter larger than the perimeter of the air bag and a top and bottom face and the second section with a perimeter larger than the perimeter of the air bag and a top and bottom face wherein the first section has an opening and the second section has a plurality of openings, and a valve placed on the top face of the first section over the opening;
aligning the perimeter of the first section with the perimeter of the second section;
sealing a majority of the perimeter of the perimeter of the first section to the perimeter of the second section while leaving an unsealed portion of the perimeter of the first section and an unsealed portion of the perimeter of the second section forming an opening between the first section and the second section;
inserting the air bag module in between the opening formed by the unsealed portion of the first section and the unsealed portion of the second section of material so that the top face of the air bag is in contact with the bottom face of the first section of material and the bottom face of the air bag is in contact with the top face of the second section of material;
aligning the bolts on the bottom face of the air bag with the plurality of openings in the second section and inserting the bolts through the openings in the second section;
sealing the unsealed portion of the first section and the unsealed portion of the second section together;
compressing the package; and
shrinking the package.

28. The method of claim 26, wherein a line of weakness is formed in the first section of material.

29. The method of claim 26, wherein a line of weakness is formed in the second section of material.

30. The method of claim 26 wherein the shrinking the package uses heat.

31. A method of encasing an inflatable object, the method comprising:
providing a cover as described in claim 1;
placing an inflatable object inside the cover;
sealing an opening through which an inflatable object is placed;
and shrinking the cover around the inflatable object.

32. The method of claim 30, wherein the cover further contains an opening through which air can be removed after placing the inflatable object inside the cover and air is removed from the cover containing the inflatable object before the shrinking step.

33. The method of claim 31, wherein the opening through which air is removed is covered with a valve prior to removal of air.

34. The method of claim 32 wherein the valve is a one way valve

35. The method of claim 31 wherein the opening through which the air is removed is sealed with an adhesive or a material having at least one adhesive coated surface after removal of air.

36. The method of claim 34, wherein the material having at least one adhesive surface is a tape.

37. The method of claim 34, wherein the material having at least one adhesive surface is a pressure sensitive coated tape.

38. A method of encasing an inflatable object, comprising:
providing a cover as described in claim 1;
wrapping an inflatable object with the cover and
sealing an opening in the cover though which the inflatable object is placed;
compressing the wrapped inflatable object; and
shrinking the wrapped inflatable object.

39. The method of claim 37 wherein the compression and shrinking are done simultaneously or nearly simultaneously.

40. The method of claim 37, further comprising providing an opening in the cover through which air can be removed and removing air from the cover encasing the inflatable object prior to compressing and shrinking.

41. The method of claim 39 wherein the air removal can range from a partial removal of air to a complete removal of air.

42. The method of claim 39, wherein the opening for removal of air is covered with a sealing mechanism prior to removal of air or after the removal of air.

43. The method of claim 41, wherein the sealing mechanism is valve when applied prior to removal of air.

44. The method of claim 42, wherein the valve is a one-way valve.

45. The method of claim 41, wherein the sealing mechanism is a tape when applied after removal of air.

46. The method of claim 44, wherein the tape is backed with pressure sensitive adhesive.
